(19) United States
(12) Patent Application Publication
(10) Pub. No.: US 2011/0265496 A1
(43) Pub. Date: Nov. 3, 2011

(54) PROCESS CHAMBER WITH INTEGRATED PUMPING

(75) Inventor: Allen J. Bartlett, New London, NH (US)

(73) Assignee: Brooks Automation, Inc., Chelmsford, MA (US)

(21) Appl. No.: 13/111,149

(22) Filed: May 19, 2011

Related U.S. Application Data
(63) Continuation of application No. PCT/US2009/065168, filed on Nov. 19, 2009.
(60) Provisional application No. 61/199,794, filed on Nov. 19, 2008.

(51) Int. Cl. B01D 8/00

(52) U.S. Cl. 62/55.5

(57) ABSTRACT

A process chamber with integrated pumping including a process chamber, refrigerators and arrays, or pumping surface, that are integral to the process chamber.

### RELATED APPLICATION(S)

This application is a continuation of International Application No. PCT/US2009/065168, which designated the United States and was filed on Nov. 19, 2009, published in English, which claims the benefit of U.S. Provisional Application No. 61/199,794, filed on Nov. 19, 2008. The entire teachings of the above applications are incorporated herein by reference.

### BACKGROUND OF THE INVENTION

1. Field

The disclosed embodiments related to a process chamber and, more particularly, to a process chamber with pumping surfaces integrated into the process space of the process chamber.

2. Brief Description of Related Developments

Vacuum process chambers are often employed in manufacturing to provide a vacuum environment for tasks such as semiconductor wafer fabrication, flat panel display fabrication, OLED fabrication, LED fabrication, solar panel fabrication, electron microscopy, and others. High vacuum below 10⁻³ torr is typically achieved in such chambers by attaching an appendage vacuum pump to the vacuum process chamber by a vacuum connection such as a flange and/or a conduit. The vacuum pump operates to remove substantially all of the gas molecules from the process chamber, therefore creating a vacuum environment.

A cryogenic vacuum pump, known as a cryopump, employs a refrigeration mechanism to achieve low temperatures that will cause many gases to condense onto a surface cooled by the refrigeration mechanism. One type of cryopump is disclosed in U.S. Pat. No. 5,862,671, issued Jan. 26, 1999, and assigned to the assignee of the present application. Such a cryopump uses a two-stage helium refrigerator to cool a cold finger to near 10 Kelvin (K).

Cryopumps generally include a low temperature second stage array, usually operating in the range of 4 to 25 K., as the primary pumping surface. This surface is surrounded by a higher temperature radiation shield, usually operated in the temperature range of 60 to 130 K., which provides radiation shielding to the lower temperature array.

In operation, high boiling point gases such as water vapor are condensed on the frontal array. Lower boiling point gases pass through that array and into the volume within the radiation shield and condense on the lower temperature array. A surface coated with an adsorbent such as charcoal or a molecular sieve operating at or below the temperature of the colder array may also be provided in this volume to remove the very low boiling point gases such as hydrogen. With gases thus condensed and/or adsorbed onto the pumping surfaces, only a vacuum remains in the process chamber.

After several days or weeks of use, the gases which have condensed onto the cryopanels, and in particular the gases which are adsorbed, begin to cause higher equilibrium pressures because the temperature gradient across the frost becomes large, the frost forms thermal shorts to warmer surfaces or the adsorbent is nearing saturation. A regeneration procedure must then be followed to warm the cryopump and thus release the gases and remove the gases from the system. During regeneration, the cryopump may be purged with warm inert gas. The inert gas hastens warming of the cryopanels and also serves to flush water and other vapors from the cryopump. Nitrogen is the usual purge gas because it is inert and is available free of water vapor. It is usually delivered from a nitrogen storage tank through a conduit and a purge valve coupled to the cryopump or as boil off from a liquid nitrogen source. The purge gas and other vapors are exhausted through the vent valve that is usually mounted to the cryopump.

After the cryopump is purged, it must be rough pumped to produce a vacuum about the cryopumping surfaces and cold finger to reduce heat transfer by gas conduction and thus enable the refrigerator to cool to normal operating temperatures. The rough pump is generally a mechanical pump coupled through a conduit to a roughing valve mounted to the cryopump.

The regeneration process may be controlled by manually turning the cryopump off and on and manually controlling the purge and roughing valves, but more typically a separate or integral regeneration controller is used in more sophisticated systems.

The two-stage helium refrigerator, arrays and radiation shield are typically packaged within a vacuum vessel. The vacuum vessel is generally integrated with a refrigerator and may also include integral controls to control the functionality of the cryopump. Alternatively, the functional control of the cryopump may be accomplished by a separate remote controller. The cryopump may be attached to a process chamber as an appendage pump to the process chamber. In this configuration, the cryopumping surface is enclosed within the cryopump vacuum vessel. The cryopump may be isolated from the process chamber by an isolation valve. The isolation valve acts as a barrier between the cryopumping surfaces of the cryopump and the process space within the process chamber. The isolation valve generally remains closed except for when the cryopump is needed to lower the pressure of the vacuum chamber.

### SUMMARY

The inclusion of an isolation valve with every appendage cryopump that may be attached to the process chamber adds a significant cost to the overall process chamber system. The location of the appendage pump is generally constrained by the layout and physical size requirements of the process chamber. Therefore, appendage pumps may not be optimally located relative to source of gas molecules entering the process space of the process chamber.

In one exemplary embodiment, a process chamber system is provided. The process chamber system includes a process chamber having a process space that is capable of performing a process within the process space, refrigerators that are removably attached to the process chamber, and arrays that are removably attached to the refrigerators, wherein the refrigerators and arrays extend into the process chamber creating a pumping surface within the process space.

In another exemplary embodiment, a process chamber system is provided. The process chamber system includes a process chamber having a process space that is capable of performing a process within the process space, a source of gas molecules that is in communication with the process space, refrigerators that are attached to the process chamber, and arrays that are attached to the refrigerators, wherein the refrigerators and arrays extend into the process chamber creating a pumping surface within the process space that are optimally located in close proximity to the source of gas molecules.

In yet another exemplary embodiment, a method of capturing gas molecules in a process space is provided. The method includes providing a process chamber having a process space that is capable of performing a process within the process space, providing a source of gas molecules that is in communication with the process space, determining optimal locations within the process chamber, attaching the refrigerators to the process chamber, and attaching the arrays to the refrigerators, wherein the refrigerators and arrays create a pumping surface that are optimally located within the process chamber.

### BRIEF DESCRIPTION OF THE DRAWINGS

The foregoing aspects and other features of the disclosed embodiments are explained in the following description, taken in connection with the accompanying drawings, wherein:

FIG. 1 illustrates a process chamber with an isolation valve and an appendage cryopump found in the prior art;

FIG. 2 is a schematic view of a refrigerator, array, refrigerator controller and compressor portions of a process chamber system in accordance with exemplary embodiments;

FIG. 3 illustrates an exemplary process chamber system incorporating features in accordance with exemplary embodiment disclosed herein;

FIG. 4 illustrates an exemplary process chamber system incorporating features in accordance with exemplary embodiment disclosed herein;

FIG. 5 illustrates an exemplary process chamber system incorporating features in accordance with exemplary embodiment disclosed herein.

### DETAILED DESCRIPTION

Although the embodiments disclosed will be described with reference to the embodiments shown in the drawings, it should be understood that the embodiments disclosed can be embodied in many alternate form of embodiments. In addition, any suitable size, shape or type of elements or materials could be used.

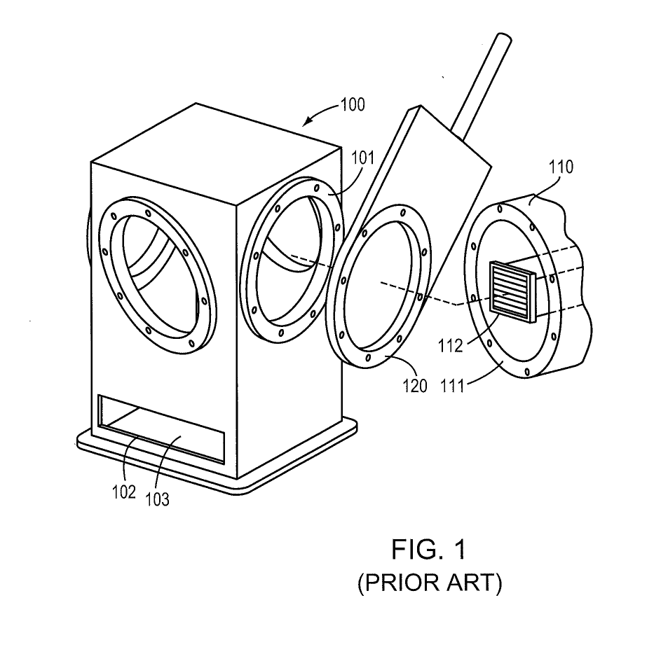

Referring to FIG. 1, there is shown a typical prior art process chamber system 100, isolation valve 120 and cryopump 110. The process chamber system has a mounting hole and flange 101 that may provide an opening to a process space 103. Isolation valve 120 may be attached to the mounting hole and flange 101 and the cryopump 110 may be secured to the isolation valve 120. Alternatively, the cryopump 110 may be secured to hole and flange 101 and the isolation valve 120 may be integral to the cryopump 110. The isolation valve 120 acts as a barrier between process space 103 and the internal mechanisms of the cryopump 110. An array set 112 may be enclosed within the cryopump 110. The array set 112, or the pumping surface 112, is contained within the cryopump 110 and may be isolated from the process space 103 by the isolation valve 120. The process chamber system 100 may also have a process hole 102. The process hole 102 interacts with an upstream process module, not shown here, that may be at substantially the same pressures as in the process space 103. The process hole 102 may be a source of gas molecules entering the process space 103 of the process chamber 100. The appendage cryopump 110 is not optimally located in close proximity to the source of gas molecules entering the process space. As such, the time in which the gas molecules are condensed and/or absorbed onto the pumping surface 112 may be increased.

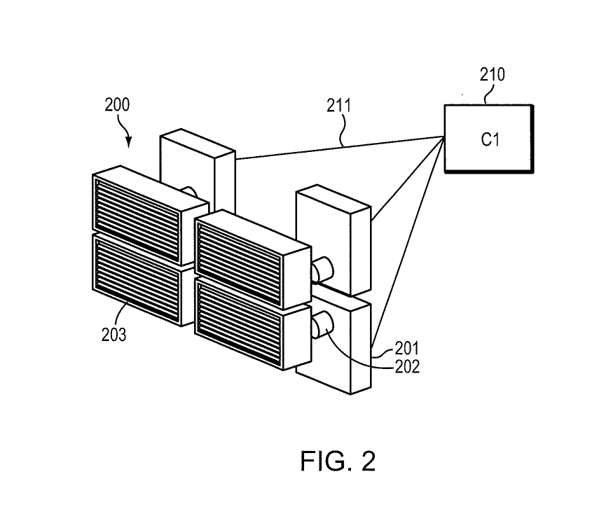

Referring to FIG. 2, there is shown schematic views of a refrigerator 202, array or array set 203, refrigerator controller 201 and compressor (C1) 210, portions of a process chamber system in accordance with exemplary embodiments. The refrigerator 202 may have a motor, electronic sensors, and valves, not shown here, and controller 201 that are common and well known in the art. Compressor (C1) 210 provides compressed working gas, such as helium, to the refrigerator 202 through lines 211. The distribution, allocation and supply of working gas may be controlled by one or more of the refrigerator controllers 201. Alternatively a controller may be integrated into the compressor (C1) 210 or may be a separate remote host controller (not shown here). The lines 211 may represent tubing that allows the flow of working gas from the compressor 210 to the refrigerator 202 and communication wires that facilitates communication between individual refrigerator controllers 201. The tubing may be manifolded at the refrigerator 202 or the tubing may be manifolded at the compressor 210. The array 203 may be removably attached to the refrigerator 202. The array 203 may be attached and/or removed from the refrigerator 202 by any quick disconnect means, such as ¼ turn, threaded locking ring, screws or bolts or any other suitable attaching means. The quick disconnect features of the array 203 and the refrigerator 202 facilitates ease of serviceability of the array or pumping surface 203. Multiple arrays 203 may be attached at different locations, not shown here, on refrigerators 202 such that the arrays may operate at different temperatures. The arrays 203 may be attached to the first and second stage of the refrigerator 202. The first stage array 203 may pump certain gases at a temperature range of 60 to 130K and the second stage array 203 may pump other certain gases at a colder temperature range of 4 to 25 k. The first stage array 203 may also provide shielding of certain gases for second stage array 203 and a common first stage array 203 may be attached to more than one refrigerator 202 for cooling. A common second stage array 203 may be attached to more than one refrigerator 202. Alternatively, arrays 203 may be attached at a single location on refrigerators 202 such that the arrays 203 may operate at substantially the same temperatures.

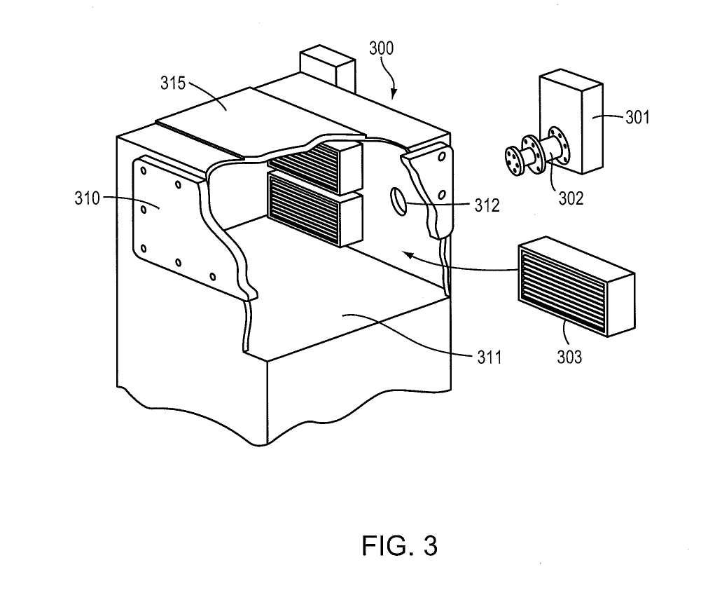

Referring to FIG. 3, there is shown an exemplary process chamber system 300 incorporating features in accordance with exemplary embodiment disclosed herein. Refrigerator 302 may be removed from and/or attached to process chamber 300 through mounting hole 312 with any common or well know attaching means, such as screws or bolts, or any other suitable attaching and vacuum sealing means. Refrigerator 302 may extend partially into process space 311 of process chamber 300. Mounting hole 312 may be fabricated directly into process chamber 300 or alternatively mounting hole 312 may be fabricated into a blank-off plate 310. Blank off plate 310, and any attached refrigerators 302, arrays 303 and refrigerator controllers 301, may be removed or attached to process chamber 300 as one module or individually. Array or pumping surface 303 may be attached to or removed from the attached refrigerator 302 by using suitable quick disconnect means. Process chamber 300 may have an access opening 315 to facilitate the removal/attachment of the refrigerator 303 from/to the process chamber 300 or blanking plate 310 or the removal/attachment of the arrays 303 from/to the refrigerator 302. Multiple arrays 303 may be attached at different locations on refrigerator 302 such that the arrays are at different temperatures. The array or pumping surface 303 may be entirely integrated into the process space 311. A roughing pump, not shown here, may be required to evacuate the process chamber 300 to a pressure below atmospheric pressure before turning on refrigerators 302. The integration of array or pumping surface 303 into the process space 311 eliminates the conductance loss associated with the vessel tubing and isolation valve, not shown here, required to mount an appendage pump 110 to the process space 311. Typical valve and tubing conductance losses between a process chamber 100 and a cryopump 110 are in the range of 20 to 40% of the available appendage pump 110 speed. In order to provide a specified pumping speed to the process space 311 an appendage pump needs to be sized 20 to 40% larger than the specified need. This “over-sizing” results in increased cost of ownership in original purchase cost and long term operating costs. Additional space on the process chamber 300 may also be required to accommodate the “over-sized” pump and attaching components. Integrated pumping eliminates the conductance loss by optimally placing the arrays or pumping surface 303 directly within the process space and in close proximity to the source of gas molecules. Specified pumping speed can be delivered with a 20 to 40% smaller array or pumping surface or additional pumping speed can be delivered through use of larger arrays that occupy more of the internal space or surface area of the process chamber.

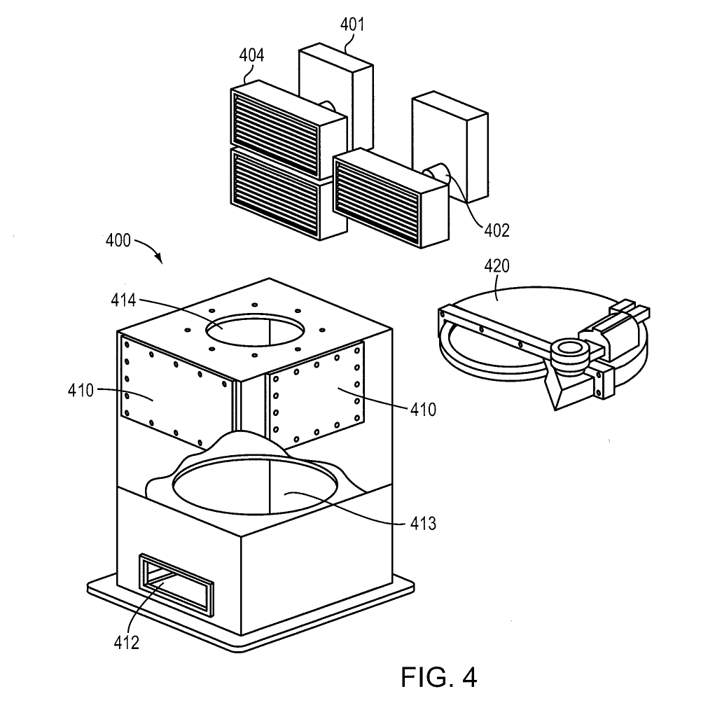

Referring to FIG. 4, there is shown an exemplary process chamber system 400 incorporating features in accordance with exemplary embodiment disclosed herein. The process chamber 400 in this example may be substantially similar to the process chamber 300 described above with respect to FIG. 3 except as otherwise noted. In this example, isolation valve 420 isolates a portion of process space 413 from integrated pump process space 414. Isolation valve 420 may be closed when the pressure in the process space 413 is different from the pressure in the integrated pump process space 414. The isolation valve 420 may be open when the pressure in the process space 413 is substantially similar to the pressure in the integrated pump process space 414 or when processing is taking place. The isolation valve 420 may be closed as part of the regeneration process of the array or pumping surfaces 404. As described in the background section, a regeneration procedure must be followed to warm the array or pumping surface 404 and thus release the gases and remove the gases from the system. The regeneration process may be a sublimation process or any common or well know process in the art. Alternatively, the regeneration process may include isolating an individual pumping surface 404 from the other pumping surfaces 404 or isolating a group of pumping surfaces 404 from the other pumping surfaces 404. Pumping surfaces 404 may be regenerated all at one time, individually and isolated from the other pumping surfaces 404 or in groups isolated from the other pumping surfaces 404. Process hole 412 interacts with an upstream process module or provides a slot for transport of substrates into the process space 413. The interaction with upstream process modules or the introduction of substrates into the process space 413 may be a source of gas molecules into the process space 413. A substrate being processed in process space 413 may have a portion of the substrate extending into the integrated pump process space 414.

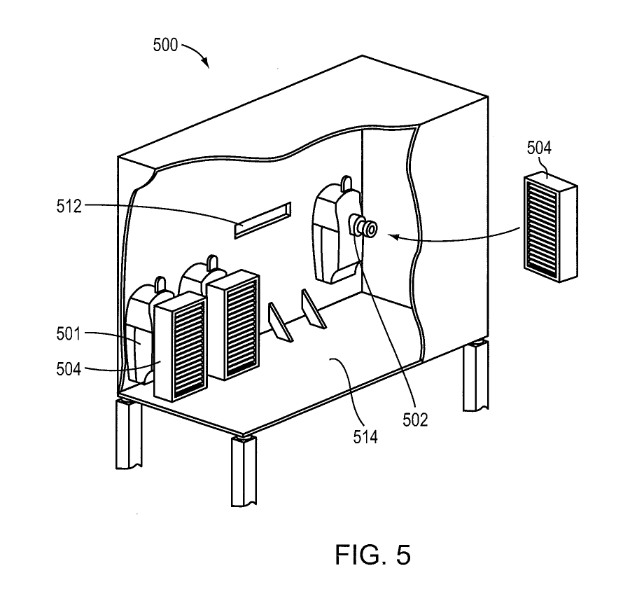

Referring to FIG. 5, there is shown an exemplary process chamber system 500 incorporating features in accordance with exemplary embodiment disclosed herein. The process chamber 500 in this example may be substantially similar to the process chamber 300 described above with respect to FIG. 3 except as otherwise noted. The refrigerator 502 and array 504 may be attached to process chamber 500 in locations that optimize the pumping speed of the gas, such as hydrogen, argon, nitrogen or other gases, contained in the process space 514. The number of refrigerators 502 and arrays 504 may be increased or decreased to vary the pumping speed for individual applications. Alternatively, the refrigerators 502 may be automatically controlled by a cryopump system controller for proper operation of the process chamber system 500. The functional control of the refrigerators may be coordinated by a common cryopump system controller. The cryopump system controller may use one or more compressors to provide a working gas to the cryopump system. A suitable cryopump system controller is described and shown in U.S. Pat. No. 7,127,901, issued Oct. 31, 2006, titled “Helium Management Control System” and U.S. Publication Number: US 2007/0107448, published May 17, 2007, titled “Helium Management Control System”, both of which are incorporated by reference herein in their entirety. The refrigerators 502 and arrays 504 may also be optimally located in close proximity relative to a gas source to improve the capture probability of the pumping surface 504. Process slot 512 may interact with a process or transfer module, not shown here, that may be a source of gas molecules or enable transport of the substrate to the processing chamber. By placing refrigerator 502 and array 504 in close proximity to process slot 512, or the gas source, the probability of capturing the gas entering the process space 514 is increased. More than one refrigerator 502 may be attached to a common array 504 or multiple portions of array set 504 may extend from refrigerator 502.

What is claimed is:

1. A process chamber system comprising:
a process chamber having a process space, wherein the process chamber is capable of performing a process;
a plurality of refrigerators removably attached to the process chamber;
a plurality of arrays removably attached to the refrigerators; and
wherein the removably attached refrigerators and arrays extend into the process chamber providing a pumping surface within the process space.

2. The process chamber system of claim 1, further comprising a process slot capable of exposing the process space to a gas molecules source.

3. The process chamber system of claim 1, further comprising a blanking plate wherein the refrigerators and the arrays are removably attached to the blanking plate and the blanking plate is removably attached to the process chamber.

4. The process chamber system of claim 1, wherein the process comprises a process step for one of semiconductor wafer fabrication, flat panel fabrication, OLED fabrication, solar panel fabrication, electron microscopy and gas chromatography.

5. The process chamber system of claim 4, wherein the semiconductor wafer fabrication process step comprises ion beam implantation.

6. The process chamber system of claim 1, further comprising a slot valve capable of isolating the pumping surface from a portion of the process space.

7. The process chamber system of claim 1, wherein plural arrays are attached to one of the refrigerators at different locations.

8. The process chamber system of claim 1, wherein one of the refrigerators has a single array attached at a single location.

9. The process chamber system of claim 1, wherein one of the arrays is attached to more than one refrigerator.

10. The process chamber system of claim 7, wherein more than one array is attached at a location on a single one of the refrigerators.

11. The process chamber system of claim 1, wherein the refrigerators are cryogenic refrigerators and the pumping surface is a cryogenic pumping surface.

12. The process chamber system of claim 1, further comprising a cryopump system controller capable of controlling a supply of working gas to the refrigerators.

13. The process chamber system of claim 1, further comprising an access opening to the process chamber.

14. A process chamber system comprising:
a process chamber having a process space, wherein the process chamber is capable of performing process;
a gas molecules source in communication with the process space;
a plurality of refrigerators attached to the process chamber;
a plurality of arrays attached to the refrigerators; and
wherein the attached refrigerators and arrays provide pumping surfaces extending into the process space that are located in close proximity to the gas molecules source.

15. The process chamber system of claim 14, wherein the gas molecules source is an upstream process module.

16. The process chamber system of claim 14, wherein the gas molecules source is a substrate introduced into the process space.

17. The process chamber system of claim 14, wherein the process comprises a process step for one of semiconductor wafer fabrication, flat panel fabrication, OLED fabrication, LED fabrication, solar panel fabrication and electron microscopy.

18. The process chamber system of claim 17, wherein the semiconductor wafer fabrication process step comprises ion beam implantation.

19. The process chamber system of claim 14, wherein the refrigerators are cryogenic refrigerators and the pumping surface is a cryogenic pumping surface.

20. The process chamber system of claim 14, further comprising a cryopump system controller capable of controlling a supply of working gas to the refrigerators.

21. A method of capturing gas molecules in a process space, comprising:
providing a process chamber having a process space, wherein the process chamber is capable of performing a process;
providing a gas molecules source in communication with the process space;
determining optimal locations within the process chamber;
attaching a plurality of refrigerators to the process chamber;
attaching a plurality of arrays to the refrigerators; and
wherein the attached refrigerators and arrays provide a plurality of pumping surfaces at the optimal locations.

22. The method of claim 21, wherein the optimal locations are in close proximity to the gas molecules source.

23. The method of claim 21, further comprising:
providing a valve capable of isolating the pumping surfaces from a portion of the process space; and
providing a roughing pump capable of rough pumping the process chamber.

24. The method of claim 23, further comprising:
isolating the pumping surfaces from the portion of the process space;
regenerating the pumping surfaces;
rough pumping the process chamber; and
unisolating the pumping surfaces from the portion of the process space.

25. The method of claim 24, wherein the regenerating the pumping surfaces comprises regenerating all the pumping surfaces, regenerating individual pumping surfaces and regenerating groups of the pumping surfaces.
